(19) United States
(12) Patent Application Publication
(10) Pub. No.: US 2009/0196961 A1
(43) Pub. Date: Aug. 6, 2009

(54) MULTI-LAYER SEMI-RIGID SHEET MATERIAL WITH HIGH THERMAL RESISTANCE FOR THE MANUFACTURE BY FOLDING OF PRODUCT PACKAGING CONTAINERS

(75) Inventors: Christian Claeys, Cavaillon (FR); Denis Ranchon, Malataverne (FR)

Correspondence Address: LUCAS & MERCANTI, LLP, 475 PARK AVENUE SOUTH, 15TH FLOOR, NEW YORK, NY, 10016, US

(73) Assignees: LAGARDE Z.I., MALATAVERNE (FR); LES CLES DU DEVELOPPEMENT, Cavaillon (FR)

(21) Appl. No.: 12/298,778

(22) PCT Filed: Apr. 26, 2007
(86) PCT No.: PCT/FR07/51176

§ 371 Date: Nov. 26, 2008

(30) Foreign Application Priority Data
Apr. 28, 2006 (FR) 0603850

(51) Int. Cl. B65D 85/00; B32B 27/00; B32B 27/08; B65B 7/00

(52) U.S. Cl. 426/127; 428/304.4; 428/166; 428/220; 428/36.7; 264/173.11; 53/467; 53/425

(57) ABSTRACT

The invention relates to a process for obtaining a multilayer material [10] consisting of semi-rigid sheets with good hold, resistance to temperatures in excess of 124° C. and low gas permeability which can be folded and intended for the manufacture by folding of containers [20] constituting an internal space for the packaging of thermally treated products, such a container [20] a process for obtaining such a multilayer material; [10] and a process for manufacturing the product packaging.

The multilayer material [10] is comprised of at least one external layer [11] of polymer material and one internal layer [12] of polymer material between which the multilayer material [10] has low permeability to gases such that there is a positive humidity sensitivity gradient [14, 13] of the gas permeability from the inside towards the outside, this gradient allowing drying of the multilayer material [10] by evaporation towards the outside during stabilisation of the multilayer material [10] following thermal processing of the packaged products.

### BACKGROUND OF THE INVENTION

This invention relates to the general field of thermally processed packaging products, in particular sterilised, pasteurised, heat filled or aseptic.

In the area of food production for example, there are several types of cans used to package vegetables, ready made meals, baby food, meats, fruits, fruit juices and sauces.

These are metal cans or tubs, glass jars, supple sachets, semi-rigid plastic containers or cans consisting of a paper-aluminium complex.

All canned and semi-canned food undergoes thermal processing, conventionally in an autoclave, to ensure preservation and/or cooking of products.

Insofar as canned food products are intended for very long term storage compared to the actual shelf-life of products exposed to air, the material used to preserve them must be gas tight, especially to oxygen, a primary factor in the expiry of products as a result of oxidation.

The different canning materials used are impermeable to oxygen but have a number of disadvantages.

With regard to metal cans, the risk of cuts or injuries exists when opening the can and deformations can lead to loss of air tightness. In addition, metal cans cannot be easily compacted.

With regard to glass jars, their fragility and their very constitution gives rise to the risk of breakage and leakage during production, transport or use of the product. In addition, glass jars cannot be compacted.

Concerning sachets which cannot be easily stacked, this type of packaging does not necessarily protect the product and it is not possible to optimise stacking volumes which gives rise to logistical problems.

Concerning paper-aluminium complexes, such as metal boxes, difficulties are encountered in terms of X-ray machines, metal detectors and foreign bodies.

Overall known materials for producing canned foodstuffs are difficult to recycle and not easily biodegraded.

Moreover, many transparent plastic materials are available to form sachets or tubs by extrusion, if need be by extrusion-moulding. Nevertheless such materials are not suited to thermal treatment or long term storage because of insufficient air tightness.

### OBJECTIVE AND SUMMARY OF THE INVENTION

The main objective of this invention therefore is to resolve these disadvantages by proposing a material that is resistant at temperatures greater than 124° C., recyclable, compactable, possibly biodegradable, controllable by metal or X-ray detectors and presenting low gas permeability, great robustness and low mass. This material makes it possible to manufacture packaging containers with optimum stacking and transport volumes which are easy to use and which can be obtained without independent waste after opening.

The invention therefore proposes a multilayer material consisting of semi-rigid sheets that can be folded and intended for the manufacture by folding of containers and constituting an internal space for the packaging of thermally processed products, said multilayer material consisting of at least one external layer of a polymer material and one internal layer of a polymer material between which the multilayer material has low gas permeability such that there is a positive humidity sensitivity gradient of the gas permeability from the inside towards the outside, this gradient allowing the multilayer material to be dried by evaporation towards the outside during the multilayer material stabilisation phase following thermal treatment of packaged products.

The term “positive humidity sensitivity gradient of the gas permeability” from the inside towards the outside means that there is an increase in the sensitivity to humidity of this permeability when going towards the outside. The term “humidity sensitivity of the gas permeability” means an increase in permeability as a function of humidity. The more sensitive a material is, the more its permeability increases when humidity rises. Humidity-sensitive materials therefore have considerable permeability to gases in a humid atmosphere although once dry, they are only very slightly permeable.

The multilayer material includes for example, between the internal layer and external layer, a first layer close to the internal layer that is not very sensitive to humidity. This means that its permeability remains constant whatever the atmospheric humidity. It also has a second layer, close to the external layer, sensitive to humidity meaning that its permeability increases with humidity.

One such configuration is illustrated in FIG. 4 representing permeability P as a function in increasing humidity H. Graph Ci represents the permeability of the first layer Graph Ce represents the permeability of the second layer. Overall permeability Ce+Ci is represented by a dotted line. It can be seen that in a humid atmosphere, the first layer approximately determines the overall permeability whereas in a dry atmosphere, the second layer mainly determines overall permeability. The two graphs Ce and Ci cross over. This corresponds to an advantageous embodiment described later.

More generally, according to the invention, the difference in permeability between the two layers from the inside towards the outside, corresponding to the difference Ce Ci, increases with increased levels of humidity. The first layer guarantees maximum permeability MP of the multilayer material which cannot exceed that of the first layer whatever the hydrometric conditions. In an advantageous embodiment illustrated in FIG. 1, the difference in permeability from the inside towards the outside is negative at first then positive. In order to allow the layer that is most sensitive to humidity to dry out, it is moreover necessary to make sure that the characteristic of the invention according to which the less humidity sensitive layer is situated on the inside of the container is complied with. Therefore, the humidity sensitivity gradient from the inside towards the outside is very useful in drying out the thermally heated multilayer material and conferring on it its properties of low permeability.

These two layers can be separated or not by another layer, for example polypropylene, whose permeability to gases is greater than that of the two layers of the material. The essential point according to the invention is thus the presence in the multilayer material of at least two layers of material being the less permeable to gas in the multilayer material and presenting a positive humidity sensitivity gradient from the outside towards the inside.

These two layers of material can also be materialised with a single layer with variable sensitivity consisting of a material whose humidity sensitivity of permeability increases towards the outside on a section of the multilayer material.

With such a multilayer material, thermal processing of the container made from the sheet and the actual constitution of the multilayer material are used to dry out the multilayer material during the stabilisation phase which includes cooling of the multilayer material.

The invention is particularly concerned with the case of thermal treatment in an autoclave of the container obtained by folding. In the course of such thermal treatment of the container, the atmosphere is generally humidity rich. As the multilayer material presents a positive humidity sensitivity gradient to gas permeability from the inside towards the outside, gas permeability will be greater towards the outside in humid atmospheres. This means that after thermal treatment, the most humidity-sensitive layers, the layers closest to the external part of the container, can be allowed to dry out by evaporation of humidity towards the outside.

Low gas permeability is therefore mainly determined by the properties of the less humidity sensitive layer represented on graph Ci, with the other layer therefore being permeable relative to the least humidity sensitive layer.

Next, after cooling, humidity evaporates as the contents of the container are hot. The low overall permeability Ce+Ci is therefore fairly similar to that of the most humidity sensitive layer Ce.

The interior of the container therefore remains permanently isolated from humidity and external gases as a result of the presence of a material with low humidity sensitivity of its gas permeability. This layer remains constantly only very slightly permeable to gases, which is not the case for the layer located closer to the outside.

On the other hand, in dry atmospheres, the gas barrier will be optimal because all the materials with low gas permeability in the multilayer material then present minimal gas permeability.

According to an advantageous embodiment, there is a positive gas permeability gradient from the inside towards the outside of the multilayer material when the multilayer material is placed in a humid atmosphere and a negative gas permeability gradient from the inside towards the outside of the multilayer material when the multilayer material is placed in a dry atmosphere.

This characteristic, presented in the illustration of the invention in FIG. 1, makes it possible to benefit from high gas tightness properties of a highly humidity sensitive material once this dries and to block the entry of gases when this humidity sensitive material is humid, the time taken for it to dry. Once dry, the humidity sensitive material then presents low permeability properties that are better than those of the not very humidity sensitive material. Gas tightness is therefore decided principally by the gas tightness of the humidity sensitive material after drying.

In one embodiment, the multilayer material includes at least one EVOH layer (copolymer of ethylene and vinyl alcohol) between the two external and internal layers of the polymer material, the humidity sensitivity gradient allowing EVOH to be dried by evaporation towards the outside.

EVOH is in fact highly sensitive to humidity and its gas tightness decreases with humidity. To allow EVOH to dry out, it is necessary to place it close to the external layer of the polymer. In fact, evacuation of humidity towards the inside is blocked as a result of the positive humidity sensitivity gradient according to which lower gas permeability is observed towards the inside of the container.

Here, the positive gradient is constituted using a material with low gas permeability having lower sensitivity to humidity than EVOH. As it dries, EVOH re-acquires low gas permeability. Once dry, this low permeability decides the permeability of gases towards the inside of the container. In fact, dry EVOH is then advantageously the material that is the least gas permeable.

According to a particular characteristic of the invention, the gradient is created by inserting a differential material constituting a gas barrier and presenting humidity sensitivity that is lower than EVOH between the interior polymer material and EVOH layer.

Such a differential material can be inserted in the course of the extrusion process, for example using a supplementary extrusion head or by complexing the differential material to the EVOH layer.

Advantageously, the differential material is a carrier polymer material coated with silicon oxide (SiOx) or aluminium oxide (AlOx) and pre-manufactured.

Such coated materials are commercially available. The carrier polymer material coated in crystallised silicon (in other words glass) has low gas permeability. This low gas permeability is insensitive to humidity. This differential material is also easy to complex with another EVOH layer, for example extruded with the outer layer of the polymer material and the inner layer of the polymer material. It is also possible to insert a polymer layer, for example polypropylene, between the EVOH layer and the differential material without departing from the principle of the invention according to which the multilayer material has a positive humidity sensitivity gradient.

One advantage of using such an oxide coated differential polymer material is its compactness. This means that a multilayer material that is not very thick can be produced. Moreover, such a coated polymer material is robust on folding. On the other hand, it is a material that cannot be extruded or thermo-moulded contrary to existing products as these processes can cause material breakages in the oxide layer and therefore ruin the gas tightness of this layer.

Once a multilayer material used to form the interior and exterior of a container has an EVOH layer and an oxide coated polyester layer, such as the EVOH layer is placed towards the exterior with respect to the coated polyester layer, a positive humidity sensitivity gradient to permeability of the multilayer material is present.

Advantageously, the differential material is positioned in such a way that the side positioned towards the inside is the side coated with SiOx or AlOx.

As the SiOx or AlOx coating is relatively fragile, it allows folding of the multilayer material in sheets without breakages as a result of extension. Moreover, it is noted that in the multilayer material according to the invention resistance to folding of the coated polymer differential material is all the better when the differential material is situated on the internal side of the multilayer material and is therefore generally folded by compression and not by extension.

The presence of a single oxide layer, fragile to extension and therefore to be folded with caution, in combination with a flexible material such as EVOH thus gives the multilayer material the possibility of being folded. It is therefore also possible that the oxide layer can be placed towards the inside of the container in order to establish a positive humidity sensitivity gradient to permeability and this characteristic also gives the whole structure the possibility of being folded. On the other hand, the multilayer material obtained cannot be thermally moulded as stretching destroys the properties of the oxide layer.

Advantageously, the carrier polymer material is polyester.

In one embodiment, the differential material is a mixture obtained from re-ground EVOH and polypropylene.

Such a material is less humidity sensitive that EVOH alone.

In addition, this differential material can be directly extruded. The manufacture of a multilayer material is therefore particularly straightforward.

According to one particular characteristic of the invention, the thickness of the multilayer material is between 100 μm and 500 μm.

According to a particular characteristic of the invention, the multilayer material is such that it allows 500 ml containers to be obtained by folding where oxygen permeability after stabilisation of the multilayer material is below 0.01 cc of O₂/24 hours at 23° C. at 50% relative humidity per container.

Such gas tightness is similar to that obtained with metal packaging with screw tops.

According to a particular characteristic of the invention, the multilayer material is transparent.

According to other particular characteristics of the invention, the multilayer material can be printed on the exterior side or by sandwiching in.

According to a characteristic of the invention, the polymer material used in the internal and external layers is mainly polypropylene.

This polymer material presents the advantage of being chemically neutral, amorphous, having good hold at temperature and the possibility of being loaded such that it can for example be peeled off. Moreover, it can be more easily recycled than glass or metal.

The invention also relates to a container for the packaging of thermally processed products obtained by folding a multilayer semi-rigid material with low gas permeability according to the invention.

Such a container can be microwaved after opening in order to heat up the food contained within.

Advantageously, the container is intended for the packaging of a product chosen from among food, hygiene and pharmaceutical products.

The invention also relates to a process for obtaining a multilayer material consisting of semi-rigid sheets with good hold, resistance to temperatures in excess of 124° C. and low gas permeability which can be folded and intended for the manufacture by folding of containers constituting an internal space for the packaging of thermally treated products. It comprises at least an extrusion step into sheets of single layer materials and/or multilayer intermediate materials and/or a complexing step of single layer materials and/or intermediate multilayer materials, comprising at least one external layer of the polymer material and one internal layer of the polymer material. The process according to the invention is such that the extrusion and/or complexing step is carried out in such a manner that the multilayer material has low permeability to gases in order to create a positive humidity sensitivity gradient of this gas permeability from the inside towards the outside, this gradient allowing drying of the multilayer material by evaporation towards the outside during stabilisation of the multilayer material following thermal processing of the packaged product.

According to one embodiment, the process according to the invention includes at least one extrusion step of the EVOH layer with the external layer of the polymer material.

In an advantageous embodiment, the process includes a step to extrude or complex an intermediate differential material making up the gas barrier and presenting lower humidity sensitivity than EVOH between the inner layer of polymer material and the EVOH layer.

According to one characteristic of the invention, the differential material is a polymer material carrier coated with silicon oxide or aluminium oxide.

According to another characteristic, the differential material is obtained in a pre-manufacturing step in the course of which a material constituting the gas barrier and presenting lower humidity sensitivity that EVOH is deposited on an intermediate polymer material. The differential material thus formed is then complexed with other intermediate single layer or multilayer materials in order to obtain the final multilayer material in sheets.

Finally, the invention relates to a process for packaging a product comprised of folding and soldering steps of a multilayer material in sheets according to the invention to make a container shape, filling the container obtained in this way with a product, sealing the container, thermally processing the container and allowing the container to cool down to room temperature in order to allow the multilayer material to dry by evaporation towards the outside of the container.

According to a particular characteristic, the soldering and/or sealing steps are carried out using a process chosen from among thermal processes and other processes using ultrasound.

In one embodiment, the thermal processing step consists in thermal processing in an autoclave at counter pressure.

Thermal processing can be chosen from among pasteurisation, sterilisation and aseptic filling.

### BRIEF DESCRIPTION OF THE DRAWINGS

Other characteristics and advantages of this invention will emerge from the description below with reference to the appended drawings which illustrate an example of the invention without being in any way limiting. On these figures:

FIGS. 1a and 1b are sections showing the multilayer structure of a multilayer material in the form of semi-rigid sheets according to the invention;

FIGS. 2a and 2b represent types of containers produced using the multilayer material according to the invention in the form of sheets;

FIGS. 3a and 3b illustrate the principle of the invention;

FIG. 4 shows permeability as a function of humidity of two layers making it possible to produce the multilayer material according to the invention;

FIG. 5 gives a detailed example of the production of a multilayer material according to the invention;

FIG. 6 illustrates an additional advantageous characteristic of the multilayer material according to the invention.

### DETAILED DESCRIPTION OF AN EMBODIMENT

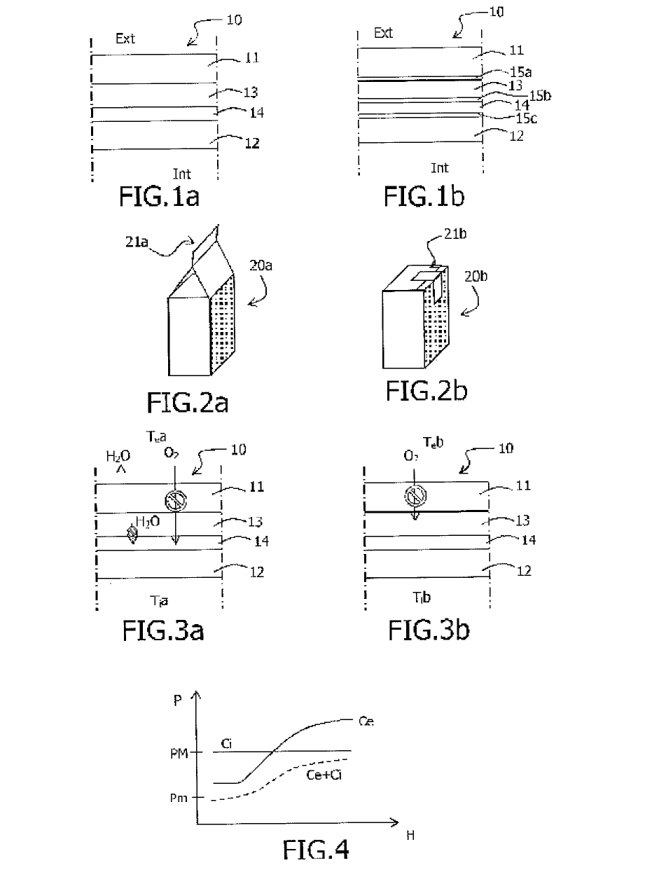

FIG. 1 illustrates the structure of a multilayer material 10 of the invention. This multilayer material includes an external layer 11 and an internal layer 12 consisting of a polymer material, for example polypropylene.

The terms <<external >> and <<internal >> designate the external and internal sides of the multilayer material, the external side being used on the outside of an internal space defined by folding the multilayer material and the inner side intended to be the internal space thus being defined.

Use of polypropylene to form the internal 12 and external 11 layers is advantageous insofar as this polymer can be used to produce resins with distinct properties. For example, a PP homopolymer has very good transparency and can be soldered with ease. The soldering properties are important because it is often this point that decides the permeability of the container obtained. There is also a <<peel >> PP which allows easy opening for certain solderings.

Polypropylene has fairly high gas permeability, about 2000 cc/24h/23° C./50% H.R./m² for a thickness of 40 μm under standard conditions but it gives the multilayer material rigidity. Advantageously, the multilayer material grade obtained is between B and 15. This makes it possible to obtain elasticity and resistance to rupture suited to folding.

Use of polyethylene in the internal 12 and external 11 layers can also be envisaged. Nevertheless, it is not possible to exceed a temperature of 121° C. during thermal processing and the appearance is translucent.

The multilayer material 10 between the two polymer layers 11 and 12 has low gas permeability such that a positive humidity sensitivity gradient of gas permeability exists, this gradient allowing drying of the multilayer material 10 by evaporation towards the exterior during the stabilisation phase of the multilayer material following thermal processing of the packaged products.

The sensitivity gradient can be continuous or discontinuous, for example using two layers of material with different properties particularly with regard to humidity sensitivity of gas permeability. According to FIG. 1a, the gradient is formed using two layers 13 and 14 consisting of materials with low gas permeability and different sensitivity to humidity of gas permeability.

Layer 13 has greater humidity sensitivity of gas permeability than layer 14.

Advantageously, sensitivity to humidity is such that there is a negative gas permeability gradient from the inside towards the outside of the multilayer material 10 when the multilayer material 10 is placed in a humid atmosphere, and a positive gas permeability gradient from the inside towards the outside of the multilayer material 10 when the multilayer material 10 is placed in a dry atmosphere. Layer 13 therefore has greater gas permeability than layer 14 in a humid atmosphere and lower permeability than layer 14 in a dry atmosphere. This is illustrated diagrammatically in FIG. 4 where graph Ce corresponds to the permeability of layer 13 and Ci corresponds to that of layer 13.

Layer 13 advantageously consists of EVOH and layer 14 is, according to a first embodiment, re-ground EVOH and polypropylene.

EVOH has low thermal shrinkage which is a big advantage for the intended applications. Other plastic materials that are not very permeable to gases are polyamides, nylon, vinylidene polychloride which have lower mechanical characteristics.

EVOH has the added advantage of being a plastic material and can thus be stretched. This confers on it a great advantage over the conventional use of aluminium sheets where it is very common for microfissures to occur, especially during folding.

With very few risks of mechanical breakage, EVOH is the choice material in terms of the air tightness of the containers obtained.

Layer 13 advantageously has a thickness of at least 10 μm and preferably around 20 μm. This makes it possible to obtain a compromise in terms of satisfactory performance during folding and air tightness allowing storage for a period of several years.

The re-ground material has intermediate properties in terms of sensitivity to humidity and permeability. As it is less sensitive to humidity, under a humid atmosphere it retains the good qualities of low gas permeability whereas pure EVOH loses these properties. On the other hand, once EVOH is dry, it has better air tightness to gases between layers 13 and 14.

Superimposing the layers in this way can be carried out using an extrusion process. The man skilled in the art of plastic manufacturing knows this technique well and thus uses a set of extrusion heads required for superimposing the layers in this way. In particular, it is necessary to add a supplementary extrusion head to achieve dissymmetry of the multilayer material. If need be, a layer of adhesive can also be used between the two separate layers as described below.

Example of an embodiment:

The multilayer material obtained has an 80 μm polypropylene external layer, an ethylene-vinylacetate copolymer based adhesive layer, a 20 μm EVOH layer, an adhesive layer, a 60 μm re-ground layer then an internal 70 μm polypropylene layer.

FIG. 1b illustrates a second embodiment of the invention. The EVOH layer 13 is bound to the external polymer layer 11 by means of a layer of an adhesive 15a, for example an ethylene-vinylacetate copolymer based adhesive. This adhesive layer is advantageously extruded at the same time as the polymer layers it binds together.

A layer 14 of a differential material constituting the gas barrier and presenting lower sensitivity to humidity than EVOH is then complexed between the internal polymer material layer 12 and the EVOH layer 13.

The differential material 14 is advantageously a carrier polymer material coated with silicon oxide (SiOx) or aluminium oxide (AlOx) and pre-manufactured. Such coated polymers are commercially available under the generic names Pet SiOx and Pet AlOx. They consist of a polyester sheet coated with a 4 μm layer of SiOx or AlOx. The SiOx or AlOx film is obtained, for example, by spraying onto an extruded/moulded polyester sheet. The oxide layers are barriers to humidity, oxygen, gases in general and ultraviolet radiation, whatever the atmospheric humidity, and this is what makes them of interest in the intended application.

The gas permeability of this differential material is equivalent to that of a non-folded aluminium sheet after thermal processing. It is about 2 cc/m²/23° C./50% R.H.

FIG. 4 precisely represents graph Ce corresponding to the permeability of the EVOH layer 13 and graph Ci corresponds to that of layer 14 coated with an oxide layer. When the humidity level is high, the oxide layer approximately determines maximum gas permeability PM and, when humidity is low, the dry EVOH layer principally decides minimum gas permeability Pm.

The differential material consisting of a carrier polymer material coated with oxide allows folding on heating to a temperature of 150° C. This differential material cannot, on the other hand, be stretched as this would break the film with glass characteristics.

Use of Pet SiOx or Pet AlOx in combination with EVOH is particularly advantageous from the point of view of the overall air tightness of a multilayer material intended for folding. While Pet SiOx carries the risk of small cracks similar to that of aluminium sheets, its use in combination with EVOH ensures very good gas tightness as a result of combining these two materials, EVOH and the oxide layer. It is also possible to use a polypropylene layer onto which a silicon or aluminium oxide layer is deposited Moreover, as the oxide-coated layer according to the invention is located towards the inside of the material, it is the elastic EVOH layer which undergoes the greatest deformation.

In order to minimise the risk of breaking the oxide film, insofar as the container forms obtained after folding are generally convex, it is advantageous to place the differential material such that the oxide film is towards the interior of the container. Thus during folding, the film will be constrained by compression and not by extension forces. This minimises the risk of rupture. The multilayer material is then able to support mechanical or thermal means of folding without any of its air tightness properties deteriorating.

Complexing is advantageously carried out using layers of adhesive 15b and 15c between the EVOH layer 13 and the differential material 14 and the differential material 14 and internal layer 12.

The man skilled in the manufacture of plastics knows these extrusion and complexing processes for use in the manufacture of a multilayer material according to the structure presented in FIG. 1b. After extrusion of a first intermediate material comprising the external layer and the EVOH layer, complexing of the differential material to the intermediate material is carried out, followed by complexing the internal layer to the differential material.

Example of an embodiment:

The multilayer material obtained has an external 80 μm thick polypropylene external peelable layer, an ethylene-vinylacetate copolymer based adhesive layer, a 20 μm EVOH layer, an adhesive layer, a 12 μm standard polyester sheet coated with a layer in the order of 1 to 4 μm of SiOx or AlOx, an adhesive layer followed by a 120 μm internal polypropylene layer.

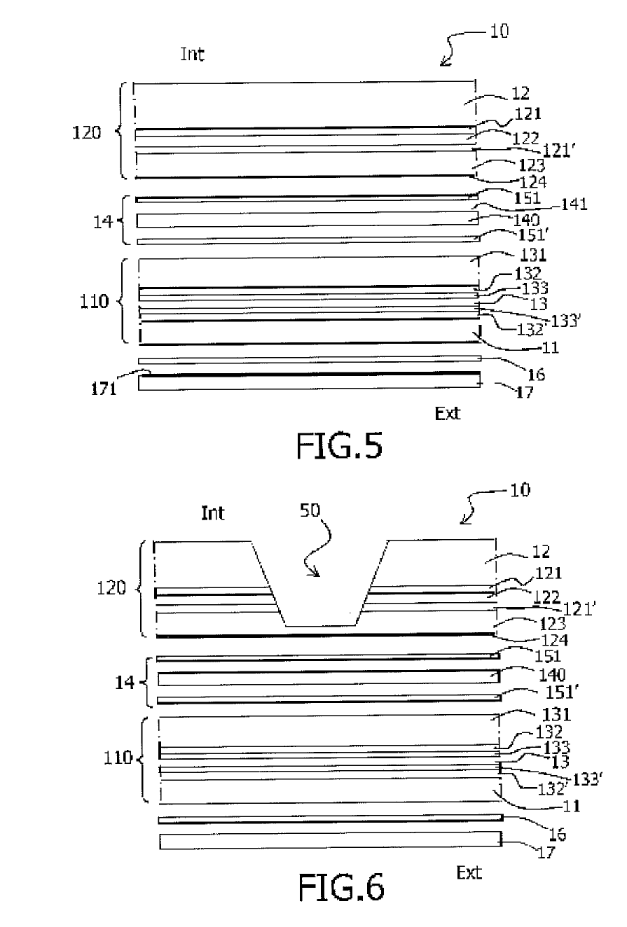

In practise, the EVOH layer and polyester sheet coated with oxide can also be separated by an additional polymer layer, for example polypropylene. This is shown in the descriptions of FIGS. 5 and 6.

FIGS. 2a and 2b are illustrations of containers 20a and 20b obtained from a multilayer material sheet according to the invention. These containers are obtained by folding and soldering the surfaces of the multilayer material sheet 20a and 20b according to the invention.

The man skilled in the art of folded packaging knows many techniques relating to the folding of sheets intended for the production of packaging. One known technique consists in folding a sheet around a column presenting a square or rectangular section. To fold the sheet, the man skilled in the art can, if need be, adapt the curve at the corners of the square or rectangle.

Next, the technique for manufacturing the container consists in binding the multilayer material with the internal side against the external side (interior/exterior soldering) or internal side, respectively external against internal side, respectively external (interior/interior soldering). This type of soldering is advantageously carried out using a thermal process or an ultrasound based process. Both these processes consist in locally melting the external and/or internal layers of the polymer material previously placed in contact with one another. The advantage of the ultrasound process is that it can be used whatever the thickness of the multilayer material whereas thermal processes require a multilayer material that is not too thick. The internal and/or external layers of polymer are homopolymer layers that can be welded to each other.

Advantageously, the folding column is heated slightly to reduce the risk of breakage and to facilitate folding.

The formats presented in FIGS. 2a and 2b make it possible to place containers side by side or stack them easily with optimisation of the overall volume occupied. In addition, there is no risk of the container breaking, as opposed to glass containers.

Storage is carried out in the same way as for metal cans, at room temperature, for example in a cupboard. The shelf life is identical to that of tin cans, in other words four years.

The air tightness obtained is similar to that obtained with a glass jar and cover.

If need be, the internal and/or external layers can be stained to give the container a colour or make it opaque. It is also possible to make the packaging locally peelable, in other words the two surfaces of the container bound to one another can be easily separated to open the container. For example, such a peelable film is situated in sections 21a and 21b in FIGS. 20a and 20b. In this case, opening the container is simple and easy. This is useful for children and elderly people. No tool is needed to open the container and there is no risk of injury on opening it.

The peel characteristic is conferred by adding loads in the areas where the two parts of the sheet making up the container are to be detached. Therefore sugar, possibly surrounded by resin, powdered lime or even talcum can be added so as to generate points which are not completely bound to each other. In this case soldering is therefore of lower quality and easy to break.

The shaped containers are then filled and sealed by soldering.

Once sealed, the container undergoes thermal treatment, generally in an autoclave where the parallelepiped shape of the container is an advantage. The processing temperature that a multilayer material according to the invention can be subject to is generally decided by the resistance to heating of the adhesives used. It is generally the materials which limit this point. Conventionally, it is possible to heat such adhesives up to a temperature of 127-128° C.

The pressure in the autoclave where the atmosphere is humid is chosen so as to maintain a constant and stable container form at the same time as increasing the temperature.

The invention moreover makes it possible to optimise autoclave use. Once heated in a humid atmosphere, on leaving the autoclave, containers 20a or 20b have such an humidity that the EVOH layer presents relatively high permeability. However, through inertia, the contents of container 20 are hot. Conventionally on leaving the autoclave, contents have a core temperature of 55° C.

As illustrated in FIG. 3a which is a diagrammatic representation of a section of the multilayer material according to the invention, the internal temperature Tᵢa is higher than the external temperature Tₑa. This makes it possible to encourage the evaporation of humidity H₂O present in particular in EVOH layer 13 towards the outside of the container 20. As illustrated, circulation of gases, in particular water H₂O, towards the inside of the container 20 is blocked by the presence of layer 14 coated with Pet SiOx which defines at this moment the minimum gas permeability of the multilayer material. Permeability from the outside towards the inside is therefore low and at the highest equal to the permeability of layer 14.

Evacuation of humidity from the inside towards the outside is limited at the multilayer material section located towards the outside starting from layer 14. The multilayer material is airtight from the inside towards the outside of the container presenting low permeability similar to that observed from the outside towards the inside.

As the container cools down, the EVOH layer 13 dries and its gas permeability decreases. As illustrated in FIG. 3b, this ensures optimum air tightness of container 20 once the container 20 cools down in such a manner that the internal temperature Tᵢb is identical to the external temperature Tₐb. In particular, the circulation of oxygen O₂ is blocked by the EVOH layer 13.

FIG. 5 is a detailed embodiment of the invention.

The multilayer material 10 is a material that is complexed in three steps using four previously prepared films. Among these four films is a film generically called 120 comprising an internal polymer layer 12 and a film comprising the EVOH layer 13 as well as the external polymer layer 11.

These two first films are previously obtained by extrusion of the materials making them up.

Thus in this example, film 120 results from extrusion of an internal 75 μm polypropylene layer 12, for example peelable, a 10 μm polyamide layer 122 between two layers 121 and 121′ of a 9 μm EVA type adhesive, and a polypropylene layer 123 treated so as to destructure its surface 124. Such treatment of the surface 124, otherwise vitrified, can be obtained by sparking, chemical attack or any other process known to change the quality of the surface state. This treatment allows good adhesion of the layers. The polyamide layer 122 has a buffer role against differential dilation of coextruded layers which undergo subsequent thermal processing.

The thickness of the internal layer 12 can vary as a function of the application in question. The overall thickness of the multilayer material is preferentially less than 500 μm but can reach thicknesses up to 1500 μm. As for the minimal thickness, this is in the order to 150 μm.

The main function of the film 120 is rigidity where thickness plays a role in the multilayer material and the possibility of soldering for which the presence of peelable or non-peelable polypropylene is useful. This material is easily soldered, for example by increasing local temperature by means of an iron applied to the exterior of the multilayer material. Ultrasound can also be applied to increase the temperature locally at the joint area only.

The film 110 results from extrusion of the layer 131 consisting of a 38 μm polypropylene used as a wedge, in other words located in the final multilayer material between the EVOH layer and the differential material layer, a 20 μm EVOH layer 13 between two symmetrical double layers around the EVOH layer and a 38 μm external polypropylene layer 11. These double layers both include a 9 μm HV layer 132 or 132′ and a 4.5 μm polyamide layer 133 or 133′. The thicknesses of the polypropylene layers 131 and 11 can vary as a function of the intended application.

The differential material 14 used here is a 12 μm polyester sheet 140 coated with a layer 141 of silicon or aluminium oxide. It is advantageously treated in such a way that its surface is destructured. It is complexed by placing the coated layer facing the side of the multilayer material intended to be the internal side of the final container, first of all with a film 120 comprising the internal layer 12 using a sterilisable adhesive layer 151 then with the film 110 comprising the EVOH layer 13 by means of a second layer of sterilisable adhesive 151′. This is then complexed by means of a sterilisable adhesive layer 16 with a polyester layer 17, for example 12 μm, treated in such a way that its surface 171 is destructured and advantageously printed. The thickness of the polyester layer 17 can vary as a function of the application intended.

In particular, it can be useful to vary the thicknesses of certain layers of the multilayer material 10 in order to change the mechanical characteristics, notably rigidity, ease of folding, etc.

FIG. 6 presents an additional advantageous characteristic for a multilayer material 10 as represented in FIG. 5. This characteristic facilitates folding and, more importantly, makes it potentially less degradable for the multilayer material 10. This additional characteristic is all the more important and useful when the multilayer material is very thick.

In fact, folding the multilayer material 10 generates greater constraints on the structure of the multilayer material 10 the thicker this is. Such constraints can be damaging in terms of the air tightness of the films used, particularly for the oxide-coated polyester film 14. The additional characteristic consists in carrying out cutting or grooving 50 by thermal or laser imprinting of film 120 comprising the internal polymer layer 12. This allows pre folding by local production in the thickness of the multilayer material 10 but without affecting low permeability layers.

This characteristic avoids any compression or stretching that might affect the oxide layer 141. Cutting or grooving 50 is advantageously carried out on all fold lines needed to obtain the final container obtained by folding the multilayer material. This characteristic is aimed at improving the ability to fold the multilayer material 10.

Cutting is advantageously carried out to a depth of around 50% of the total thickness of the multilayer material. It should be noted that this is a means of carrying out cutting a groove in the film 120, the rigidity layer which alone generally represents over 50% of total thickness as presented in the example of FIG. 5.

In summary, the invention makes it possible to obtain a multilayer material for the manufacture of containers with minimal oxygen permeability, if need be transparent, light, not very fragile, recyclable, even biodegradable, easily compactable, controllable by X-ray or metal detectors, microwaveable, thermally treatable from 60° C. to temperatures in excess of 125° C., easily stackable in order to optimise stacking volumes and easy to open and without independent waste on opening. The multilayer material obtained does not undergo significant deformation in the course of thermal processing, notably in the autoclave.

The invention thus makes it possible to offer direct reheating in a microwave oven or water bath without using another container. Use of the product outside the house, for example in the workplace, office, school is made easy.

The invention allows the product to be seen through the packaging, a possibility usually only offered by glass jars. This visibility makes identification easy and direct.

In the same way as all containers intended for commercialisation of portions, containers manufactured according to the invention present a playful appearance allowing each person to add a side dish to a communal meal.

The multilayer material according to the invention finally presents the advantage of not being very costly. Its use costs approximately the same as a tin can and is less expensive than a cardboard-paper complex. Moreover, printing and labelling techniques on plastic materials are known to make it easier to provide the consumer with information.

Finally, it should be noted that various applications are available according to the principles of the invention as stated in the following claims.

1. Multilayer material in a semi-rigid sheet having hold and resistance to temperatures in excess of 124° C. and high impermeability to gases and intended for the manufacture by folding of containers defining an internal space for the packaging of thermally treated products wherein it consists of at least one external layer of a polymer material and one internal layer of a polymer material between which the multilayer material has low gas permeability such that there is a positive humidity sensitivity gradient of this gas permeability from the inside outwards, this gradient allowing the multilayer material to be dried by evaporation towards the outside during the multilayer material stabilisation phase following thermal treatment of packaged products.

2. Multilayer material according to claim 1 wherein there is a positive gas permeability gradient from the inside towards the outside of the multilayer material when the multilayer material is placed in a humid atmosphere and a negative gas permeability gradient from the inside towards the outside of the multilayer material when the multilayer material is placed in a dry atmosphere.

3. Multilayer material according to claim 1 wherein it includes at least one EVOH layer (copolymer of ethylene and vinyl alcohol) between the two external and internal layers of the polymer material, the humidity sensitivity gradient allowing EVOH to be dried by evaporation towards the outside.

4. Multilayer material according to claim 3 wherein the gradient is created by inserting a differential material constituting a gas barrier and presenting humidity sensitivity that is lower than EVOH between the interior polymer material and EVOH layer.

5. Multilayer material according to claim 4 wherein the differential material is a carrier polymer material coated with silicon oxide (SiOx) or aluminium oxide (AlOx) and premanufactured.

6. Multilayer material according to claim 5 wherein the differential material is positioned in such a way that the side positioned towards the inside is the side coated with SiOx or AlOx.

7. Multilayer material according to claim 5 wherein the carrier polymer material is polyester.

8. Multilayer material according to claim 1 wherein the differential material is a mixture obtained from re-ground EVOH and polypropylene.

9. Multilayer material according to claim 1 wherein cutting or grooving is carried out in the internal layer so as to locally reduce the thickness of the material along the fold lines allowing the container to be shaped by folding.

10. Multilayer material according to claim 1 wherein its thickness is between 100 μm et 500 μm.

11. Multilayer material according to claim 1 wherein 500 ml containers to be obtained by folding where oxygen permeability after stabilisation of the multilayer material is below 0.01 cc of O₂/24 hours at 23° C. at 50% relative humidity per container.

12. Multilayer material in sheets according to claim 1 wherein it is transparent.

13. Multilayer material in sheets according to claim 1 wherein the polymer material used in the layers of polymer material is mainly polypropylene.

14. Container for packaging thermally proceeded products obtained by folding a semi-rigid multilayer material in sheets with high impermeability to gases according to claim 1.

15. Container according to claim 14 wherein it can be microwaved after opening in order to heat up the food contained within.

16. Container according to claim 14 wherein it is intended for the packaging of a product chosen from among food, hygiene and pharmaceutical products.

17. Process for obtaining a multilayer material in semi-rigid sheets having hold and resistance to temperatures in excess of 124° C. and high impermeability to gases and intended for the manufacture by folding of containers defining an internal space for the packaging of thermally treated products wherein it consists of at least the following steps:
Extrusion into sheets of single layer materials and/or multilayer intermediate materials and/or complexing single layer materials and/or intermediate multilayer materials, comprising at least one external layer of a polymer material and one internal layer of a polymer material. The process according to the invention is such that the extrusion and/or complexing step is carried out in such a manner that the multilayer material has low permeability to gases in order to create a positive humidity sensitivity gradient of the gas permeability from the inside towards the outside, this gradient allowing drying of the multilayer material by evaporation towards the outside during stabilisation of the multilayer material following thermal processing of the packaged product.

18. Process according to claim 17 wherein it comprises at least one extrusion step of an EVOH layer with the external layer of the polymer material.

19. Process according to claim 18 wherein it comprises a step to extrude or complex an intermediate differential material acting as a gas barrier and presenting sensitivity to humidity lower than EVOH between a layer of polymer material and the EVOH layer.

20. Process according to claim 19 wherein the differential material is a carrier polymer material coated with silicon oxide or aluminium oxide and pre-manufactured.

21. Process according to claim 19 wherein the differential material is obtained in a pre-manufacturing step in the course of which a material constituting the gas barrier and presenting lower humidity sensitivity that EVOH is deposited on an intermediate polymer material, the differential material thus pre-manufactured then being complexed with other intermediate single layer or multilayer materials in order to obtain the final multilayer material in sheets.

22. Process according to claim 17 wherein it includes a cutting or grooving step carried out in the internal layer so as to locally reduce the thickness of the material along the fold lines allowing the container to be shaped by folding.

23. Process for packaging a product consisting of the following steps:
Folding and soldering steps of a multilayer material in sheets according to claim 1,
Filling the container obtained in this way with a product,
Sealing the container by soldering,
Thermally processing the container,
Allowing the container to cool down to room temperature in order to allow the multilayer material to dry by evaporation towards the outside of the container.

24. Process for packaging a product according to claim 23 wherein the sealing step is carried out using a process chosen from among thermal processes and processes using ultrasound.

25. Process for packaging a product according to claim 23 wherein the thermal processing step consists in thermal processing in an autoclave at counter pressure.

26. Process for packaging a product according to claim 23 wherein thermal treatment is chosen from among pasteurisation, sterilisation and aseptic filling.
